(19) United States
(12) Patent Application Publication
(10) Pub. No.: US 2009/0147428 A1
(43) Pub. Date: Jun. 11, 2009

(54) METAL CASE AND UNIT CELL FOR PREVENTING ELECTROSTATIC DISCHARGE AND METHOD OF FORMING THE SAME

(75) Inventors: Jong Hwa KWON, Daejeon (KR); Dong-Uk SIM, Daejeon (KR); Sang Il KWAK, Daejeon (KR); Hyung Do CHOI, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/332,028

(22) Filed: Dec. 10, 2008

(30) Foreign Application Priority Data
Dec. 11, 2007 (KR) 10-2007-0128033

(51) Int. Cl. H05F 3/00; B23P 17/00

(52) U.S. Cl. 361/212; 29/592.1

(57) ABSTRACT

A metal case for preventing electrostatic discharge includes an electromagnetic bandgap restricting current generated by electrostatic discharge and formed by arrangement of unit cells. Further, a method of forming a metal case preventing an electrostatic discharge includes forming an electromagnetic bandgap by arranging a plurality of unit cells; and forming a metal case having the electromagnetic bandgap to restrict current generated by the electrostatic discharge.

### CROSS-REFERENCE TO RELATED APPLICATIONS

The present invention claims priority of Korean Patent Application No. 10-2007-0128033, filed on Dec. 11, 2007, which is incorporated herein by reference.

### FIELD OF THE INVENTION

The present invention relates to a metal case and a unit cell for preventing electrostatic discharge and a method of forming the same, and more particularly to a metal case and a unit cell for preventing electrostatic discharge to reduce influence by the electrostatic discharge using electromagnetic bandgap, and a method of forming the same.

This work was supported by the IT R&D program of MIC/IITA [2007-F-043-01, Study on Diagnosis and Protection Technology based on EM].

### BACKGROUND OF THE INVENTION

Recently, thanks to rapid development of electrics and electronics, electric devices, electronic device, and multimedia IT devices are becoming miniaturized, light in weight, highly integrated to be portable, and have a high processing rate for the transmission and reception of a great deal of information and for the real time processing. However, the electric and electronic devices including high-end IT equipment are driven with a low power so as to process signals at a high rate and to reduce power consumption. For this reason, the devices are sensitive to noise generated from the surroundings and often malfunction. The most cases where the electric and electronic devices malfunction against the external noise is known to be caused by phenomena generated by electrostatic discharge (ESD). It is known that the ESD occurring on a charged metal body causes strong electromagnetic interference to neighboring and distant devices and systems. The ESD is known as one of the most serious sources of electromagnetic interference for the electric and electronic devices and researches and developments are proceeding inside and outside of the country now. Since various small sized wire/wireless electric and electronic devices are frequently used in restricted spaces such as homes, offices, vehicles, and the like, distances from the noise sources are shortened so that the influence of the ESD is increasing. The high processing rate and the low power increase the possibility of malfunction of the electric and electronic devices caused by the ESD.

The ESD means a phenomenon that charges, generated when two substances at different electric potentials contact each other, move between the two substances due to charging or electrostatic induction. In other words, the ESD is a phenomenon that energy is instantly emitted from the charged substance by dielectric breakdown of a surrounding medium or contact with a grounding body. Generally, the ESD occurs for several ps to 1 micro-second and appears in the form of a pulse having energy with a frequency of approximately 1 to 500 MHz from 100 V to 15 kV (maximum 25 kV) under normal environment.

In order to measure the ESD, a cause of static electricity must be considered. According to a principle for a structure of substances, every substance consists of a nucleus containing positively charged protons and negatively charged electrons revolving around the nucleus, and keeps a neutral state when the number of electrons is equal to that of protons in the nucleus. When two substances having different properties contact each other, electrons (particularly, electrons on an orbit farthest from the nucleus) are separated from molecules of a corresponding substance and move free. In this state, when the contacting substances are moved apart from each other, one of the substances gains electrons and is negatively charged and the other loses electrons and is positively charged. For example, when two film type substances are strongly rubbed on each other and separated to measure static electricity, one of them gains electrons to be negatively charged and the other loses electrons to be positively charged. The stronger the rubbing pressure is and the faster the separation is, the greater the amount of charges on the films is. There are various causes of the charging such as contact, separation, rubbing, collision, deformation, transformation, ion absorption, and the like. Magnitude of charging is determined by contacting area and pressure, rubbing frequency and speed, and a temperature difference between two substances, and polarities of the charged substances are determined by types and surface states of the substances.

Generally, the uncontrolled static electricity brings ignition or explosion of combustible material or explosives (for example, an arsenal, a rocket, gunpowder, a granary, and lime), and papers, fibrous material, plastic to stick to each other in a printing house, a textile mill, a plastic factory, and the like causing many problems. It is known that the charged substance collects dust or foreign matter and causes several problems such as electrical shock. Since discharged energy due to the ESD, even if it is only several mJ, may breakdown a semiconductor device or causes electronic noise, malfunction of an electronic device such as a computer, an automatic device, and the like arises. The ESD may be used for a useful purpose like other natural phenomena. An electronic copying machine, dust control in a workshop, and paint spraying use the ESD. However, damages by static electricity are more serious due to miniaturization and integration of electric and electronic devices and apparatuses recently. Since a small device uses low power, possibility of damage by the static electricity increases.

When the static electricity is discharged from a charged human body or other objects to an electronic part or apparatus, discharged current passes through a low resistance area of the electronic part or an object to be painted and a magnitude thereof is expressed by the following equation.

$$I = \frac{Δ q}{Δ t}$$

where I is discharged current, q is a discharged amount, and t is discharging time. Since the discharge is carried out for a short time, the discharged current is strong as the discharged amount is large. Due to the relation of E(H)∝I , thermal energy generated when the discharged current is strong causes troubles such as thermal breakdown of a chip in the electronic device and vaporization of metal in proportion to the discharged current.

Deterioration and breakdown of the electronic part caused by the ESD occur when a product is charged or discharged with the static electricity by contact with a human body. Frictional electricity occurring between the human body and clothes during the movement of a human body causes electrification with a floor. When a worker handles electric parts sensitive to the static electricity without prevention of the static electricity charged to the worker, silicon oxide with low breakdown voltage is shorted and deterioration and breakdown of a product occurs. The most damage by the static electricity arises in this case.

Moreover, the product serves as a capacitor to be charged with or to discharge the static electricity. This occurs when an object from which frictional electricity is easily generated is charged with the static electricity during carrying or automatic conveying and the static electricity is very rapidly discharged to surfaces of pins of an electronic part with low resistance. The deterioration and breakdown arise when a charged amount of a product charged with an electric field is changed. When a position of a charged object is suddenly changed in a state of static induction occurring between the charged object and an electronic part or the charged object rapidly passes between an electric wire on which the static induction occurs, the sudden change of the static induction influences dielectrics and oxides resulting in a short circuit.

There are existing methods of removing the ESD such as a method of removing the static electricity by removing factors to cause rubbing or by adjusting humidity and temperature, a method of grounding an apparatus and discharging locally accumulated charges, and a method of coating a metal portion with insulation to mitigate concentration of an electric field. In addition, a method of adequately shielding to increase radiation and conductivity of an apparatus or of increasing endurance against the ESD using a loss filter such as ferrite core is applied. These existing methods against the ESD are not suitable to various apparatuses and a portable terminal used while moving under electromagnetic circumstance where wireless communications are used, and additional costs for a loss filter such as a ferrite core and insulation coating are required. Thus, more effective solutions for the ESD are urgently required.

### SUMMARY OF THE INVENTION

In view of the above, the present invention provides a metal case and a unit cell including an electromagnetic wave controlling structure such as an electromagnetic bandgap of electric, electronic, and IT apparatuses having a metal member and a metal case to protect internal parts from damage by electrostatic discharge by reducing an amount of surface current on the metal case of the apparatus and an amount of electric current flowing into the apparatus through the metal case and openings, and a method of forming the same.

In accordance with a first aspect of the present invention, there is provided a metal case for preventing electrostatic discharge including: an electromagnetic bandgap on the metal case to restrict current generated by electrostatic discharge on the metal case, wherein the electromagnetic bandgap is formed by arrangement of unit cells.

Preferably, the electromagnetic bandgap is formed by forming holes on the surface of the metal case.

Preferably, the electromagnetic bandgap is formed by using a metal patch and dielectrics.

Preferably, each of the unit cells has one of various shapes such as a triangular shape, a rectangular shape and the like.

Preferably, the metal case further includes a metal plate without holes provided at the lower end of the electromagnetic bandgap.

Preferably, the metal case further includes dielectrics provided between the electromagnetic bandgap and the metal plate to hold the electromagnetic bandgap.

In accordance with a second aspect of the present invention, there is provided an electrostatic discharge preventing unit cell of an electromagnetic bandgap, wherein the electromagnetic bandgap restricts current generated by electrostatic discharge.

Preferably, the electromagnetic bandgap is formed by arrangement of a plurality of unit cells.

In accordance with a third aspect of the present invention, there is provided a method of forming a metal case preventing an electrostatic discharge. The method includes forming an electromagnetic bandgap by arranging a plurality of unit cells; and forming a metal case having the electromagnetic bandgap to restrict current generated by the electrostatic discharge.

In accordance with the present invention, the electromagnetic wave controlling structure such as an electromagnetic bandgap is applied to electric, electronic, and IT apparatuses having a metal member and a metal case such that surface current flowing on the metal case of the apparatus is reduced, and an amount of electric current flowing into the apparatus through the metal case and openings is reduced so as to protect internal parts from damage due to the electrostatic discharge.

### BRIEF DESCRIPTION OF THE DRAWINGS

The above and other features of the present invention will become apparent from the following description of embodiments given in conjunction with the accompanying drawings, in which:

FIG. 1 is a perspective view illustrating a metal case for preventing electrostatic discharge in accordance with an embodiment of the present invention;

FIG. 2 is a perspective view illustrating electrostatic discharge guns applied to a metal housing in accordance with another embodiment of the present invention;

FIG. 3 is a graph comparing signal transmission properties of the metal case for preventing electrostatic discharge in accordance with the embodiment of the present invention with a metal case without an electromagnetic bandgap for preventing electrostatic discharge;

FIG. 4 is a view illustrating unit cells for preventing electrostatic discharge in accordance with another embodiment of the present invention;

FIG. 5 is a view illustrating products to which the unit cells in accordance with still another embodiment of the present invention are applied;

FIG. 6 is a flowchart illustrating a method of forming a metal case for preventing electrostatic discharge in accordance with still another embodiment of the present invention; and

FIG. 7 is a view illustrating a metal case to which the unit cell for preventing electrostatic discharge in accordance with still another embodiment of the present invention is applied.

### DETAILED DESCRIPTION OF THE EMBODIMENTS

In this embodiment, various electromagnetic wave controlling structures such as an artificial magnetic conductor, a high impedance surface, an electromagnetic bandgap and the like may be employed, terms expressed by the electromagnetic bandgap in other parts of this description may be substituted for the artificial magnetic conductor or the high impedance surface.

Hereinafter, embodiments of the present invention will be described in detail with reference to the accompanying drawings which form a part hereof.

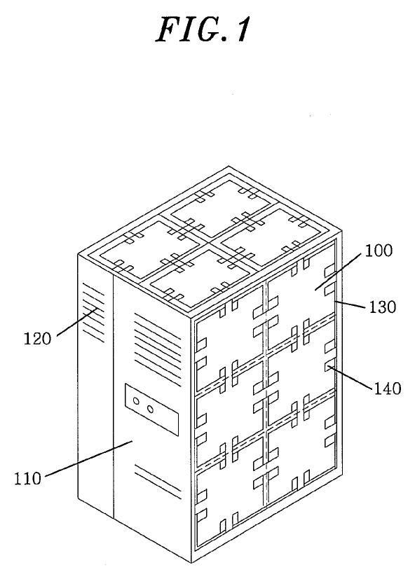

FIG. 1 is a perspective view illustrating a metal case for preventing electrostatic discharge in accordance with an embodiment of the present invention. As illustrated in the drawing, the metal case for preventing electrostatic discharge (ESD) in accordance with the embodiment of the present invention includes an electromagnetic bandgap 100, a metal housing 110 and openings 120.

The electromagnetic bandgap 100 restricts current generated by the ESD and is formed by arrangement of a plurality of the unit cells 130 having holes 140.

The electromagnetic bandgap 100 is formed by forming holes on the surfaces of the metal housing 110 or using a metal patch and dielectrics.

Each of the unit cells 130 may be a triangular shape or a rectangular shape.

The electromagnetic bandgap 100 is arranged at a portion where the openings 120 necessary for venting the metal housing 110 are not formed, such that other areas are not influenced by the ESD generated at a position of an appliance.

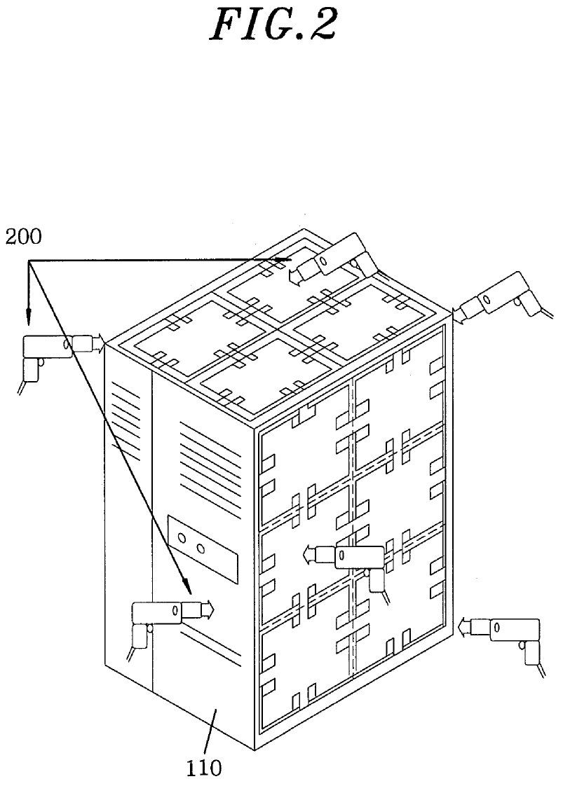

FIG. 2 is a perspective view illustrating electrostatic discharge guns applied to a metal housing in accordance with another embodiment of the present invention. Referring to FIG. 2, the ESD guns 200 are applied to the metal case 110 such that electrostatic discharging properties are exhibited. The ESD guns 200 are tools, proposed by International organization such as International Electrotechnical Commission (IEC), to generate the electrostatic discharge properties. It is understood that the ESD is possibly generated at any areas formed with metal when the ESD test is performed for every position to which a human hand or other charged objects contact.

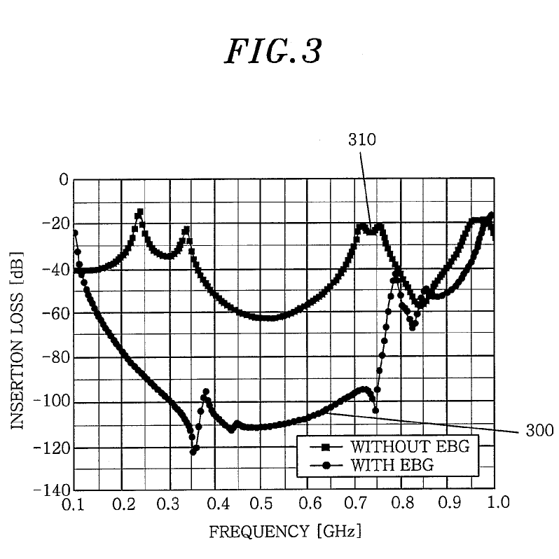

FIG. 3 is a graph comparing signal transmission properties of the metal case for preventing electrostatic discharge in accordance with the embodiment of the present invention with a metal case without an electromagnetic bandgap 100 for preventing electrostatic discharge. Referring to FIG. 3, it can be understood that the metal case employing the electromagnetic bandgap 100 restricts signals, that is, flow of current approximately over 20 dB at band from 100 MHz to 800 MHz (300 and 310). Thus, the metal case for preventing electrostatic discharge in accordance with the embodiment of the present invention can restrict a considerable amount of current generated by the ESD having energy with frequency ranging from 1 MHz to 500 MHz.

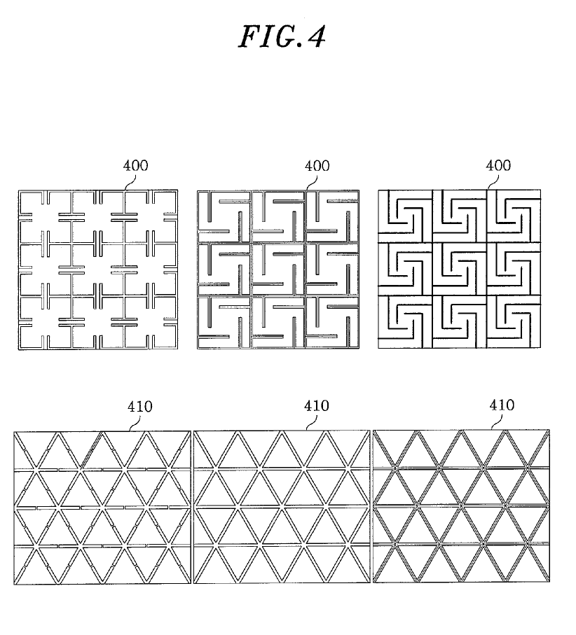

FIG. 4 illustrates unit cells for preventing electrostatic discharge in accordance with still another embodiment of the present invention. Referring to FIGS. 1 and 4, the electromagnetic bandgap 100 is formed by arrangement of the unit cells 130 in which neighboring conductors are connected to each other by a preset distance. Each of the unit cells 130 may be formed

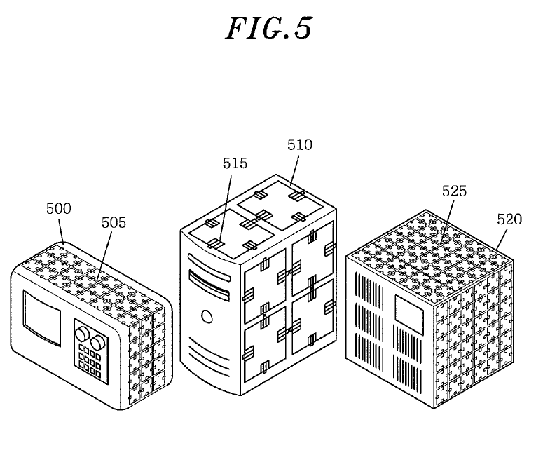

FIG. 5 is a view illustrating products to which the unit cells in accordance with still another embodiment of the present invention are applied. Referring to FIG. 5, respective unit cells 505, 515, and 525 for preventing electrostatic discharge are applied to an IT and measuring apparatus 500, a personal computer case 510, and a base station equipment 520.

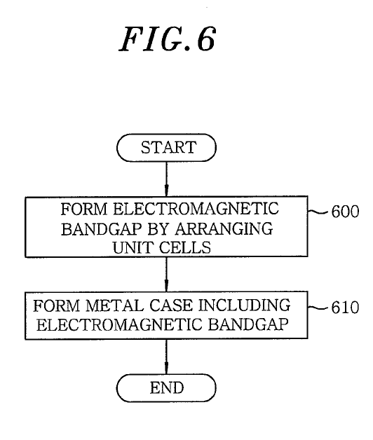

FIG. 6 is a flowchart illustrating a method of forming a metal case for preventing electrostatic discharge in accordance with still another embodiment of the present invention. Referring to FIGS. 1 and 6, firstly the unit cells 130 are arranged to form the electromagnetic bandgap 100 (600). Each of the unit cells 130 may have a triangular shape or a rectangular shape. The electromagnetic bandgap 100 restricts current generated by the ESD and may be formed using a metal patch and dielectrics.

Next, the metal housing 110 including the electromagnetic bandgap 100 formed in step 600 is formed (610). In this case, the electromagnetic bandgap 100 may be formed by forming holes on the surfaces of the metal housing 110.

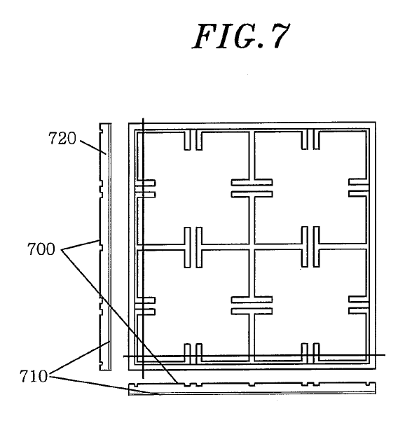

FIG. 7 is a view illustrating a metal case to which the unit cell for preventing electrostatic discharge in accordance with still another embodiment of the present invention is applied. Referring to FIG. 7, the metal case in accordance with the embodiment of the present invention includes metal surfaces 700 to which an electromagnetic bandgap pattern is applied, continuous metal surfaces 710 without discrete portions such as holes, and dielectrics 720. When the electromagnetic bandgap is formed as illustrated in FIG. 1, flow of current generated on the surfaces of the metal case is blocked so that an amount of current flowing into the metal housing through openings can be reduced and internal parts of the metal case can be protected. However, since current could flow into the metal housing through holes when the electromagnetic bandgap is formed by making the holes directly on the metal case, the structure as illustrated in FIG. 7 may be considered.

In other words, the metal case may include a continuous metal plate 710 without discrete portions such as holes provided to the lower end of the electromagnetic bandgap or the metal surfaces 700 to which the electromagnetic bandgap is applied. The continuous metal plate 710 without discrete portions can prevent current and electromagnetic waves from flowing into the metal case through the holes.

The metal case may further include dielectrics 720 between the electromagnetic bandgap or the metal surfaces 700 to which the electromagnetic bandgap is applied and the continuous metal plate 710 without discrete portions. The dielectrics 720 hold the electromagnetic bandgap pattern.

While the invention has been shown and described with respect to the embodiments, it will be understood by those skilled in the art that various changes and modifications may be made without departing from the scope of the invention as defined in the following claims.

What is claimed is:

1. A metal case for preventing electrostatic discharge comprising:
an electromagnetic bandgap on the metal case to restrict current generated by electrostatic discharge on the metal case,
wherein the electromagnetic bandgap is formed by arrangement of unit cells.

2. The metal case of claim 1, wherein the electromagnetic bandgap is formed by forming holes on the surface of the metal case.

3. The metal case of claim 1, wherein the electromagnetic bandgap is formed by using a metal patch and dielectrics.

4. The metal case of claim 1, wherein each of the unit cells has one of various shapes such as a triangular shape, a rectangular shape and the like.

5. The metal case of claim 1, further comprising a metal plate without holes provided at the lower end of the electromagnetic bandgap.

6. The metal case of claim 5, further comprising dielectrics provided between the electromagnetic bandgap and the metal plate to hold the electromagnetic bandgap.

7. An electrostatic discharge preventing unit cell of an electromagnetic bandgap, wherein the electromagnetic bandgap restricts current generated by electrostatic discharge.

8. The unit cell of claim 7, wherein the electromagnetic bandgap is formed by arrangement of a plurality of unit cells.

9. The unit cell of claim 7, wherein the unit cells are formed by using a metal patch and dielectrics.

10. The unit cell of claim 7, wherein each of the unit cells has one of various shapes such as a triangular shape, a rectangular shape and the like.

11. A method of forming a metal case preventing an electrostatic discharge, the method comprising:
forming an electromagnetic bandgap by arranging a plurality of unit cells; and
forming a metal case having the electromagnetic bandgap to restrict current generated by the electrostatic discharge.

12. The method of claim 11, wherein the electromagnetic bandgap is formed by making holes on the surface of the metal case.

13. The method of claim 11, wherein the electromagnetic bandgap is formed by using a metal patch and dielectrics.

14. The method of claim 11, wherein each of the unit cells has one of various shapes such as a triangular shape, a rectangular shape and the like.
